(19) United States
(12) Patent Application Publication
(10) Pub. No.: US 2005/0098085 A1
(43) Pub. Date: May 12, 2005

(54) Laser designating apparatus

(76) Inventor: Kung Yun Wang, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/704,731

(22) Filed: Nov. 12, 2003

(51) Int. Cl. F21S 10/00

(52) U.S. Cl. 116/202

(57) ABSTRACT

A laser designating apparatus includes a 1.5 V carbon-zinc battery (an 1.5V alkaline battery or a 1.2V nickel-metal hydride battery), a control circuit and a laser diode, wherein the control circuit is connected to the electric output port of the mentioned batteries to transform the output electricity of the batteries into 3 V (or 4.5 V); the electricity of the batteries is for the use of the laser diode. The laser diode is started up by using a battery and a control circuit.

### FIELD OF THE INVENTION

The present invention relates to a laser designated apparatus, particularly to an apparatus of laser diodes switched on by only one battery and a control circuit.

### BACKGROUND OF THE INVENTION

Please refer to FIG. 1, it is a schematic view of a prior art laser-pointing pen (or laser designator, as FIG. 3 shows). The laser-pointing pen generally requires three mercury batteries 60 in serial connection to provide sufficient voltage level for operation. The electric voltage level provided by one single battery is 1.5 V; therefore, the electric voltage level of three batteries is 4.5 V.

Due to problems of environment pollution of the mercury in the mercury battery 60, low capacity, high price, and low efficiency, users don't replace the mercury batteries 60 frequently; young children also may eat the batteries incautiously. Hence the reusing rate of the laser-pointing pen is reduced substantially.

Please refer to FIG. 2, there is a pen-shaped laser designator switched on by two carbon-zinc batteries 65 with the electric voltage level 1.5 V respectively. In other words, the pen-shaped laser designator is operated under the electric power 3 V. However, the laser designator shown in FIG. 2 is too long to be used in the pen-shaped structure.

Owing to the advantage of long using time of carbon-zinc batteries, the consumers will be willing to reuse the laser designator by replacing prior art mercury batteries with carbon-zinc batteries and reduce the using number of the carbon-zinc batteries. And it is also convenient to buy the carbon-zinc batteries.

### SUMMARY OF THE INVENTION

It is an object of the present invention to start up laser diode by only one battery and a control circuit.

It is another object of the present invention to provide a laser designator that does not use mercury batteries to avoid problems of environment pollution and to prevent children from eating the batteries.

It is still another object of the present invention to provide a laser designator with long using time and low power consumption. To achieve the object, the present invention provide a control circuit to connect the electric output port of the single battery, and the circuit transforms the electric power of the battery into 3 V (or 4.5 V) to supply electric power to a laser diode.

The above-mentioned single battery may be a 1.5V carbon-zinc battery, a 1.5V alkaline battery or a 1.2V nickel-metal hydride battery.

The various objects and advantages of the present invention will be more readily understood from the following detailed description when read in conjunction with the appended drawing, in which:

### BRIEF DESCRIPTION OF DRAWING

FIG. 1 shows an exploded view of a prior art laser-pointing pen;

FIG. 2 shows a perspective view of a prior art pen-shaped laser designator;

FIG. 3 shows another perspective view of the prior art pen-shaped laser designator;

FIG. 4 shows the circuit diagram of the present invention;

FIG. 5 shows another circuit diagram of the present invention;

FIG. 6 shows the embodiment of the laser-pointing pen in the present invention;

FIG. 7 shows a level according to a preferred embodiment in the present invention;

FIG. 8 shows a key ring according to another preferred embodiment in the present invention; and

FIG. 9 shows a laser designator according to still another preferred embodiment in the present invention.

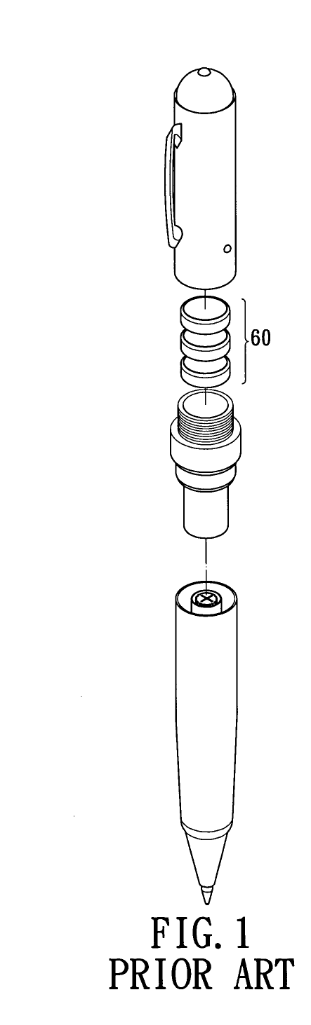

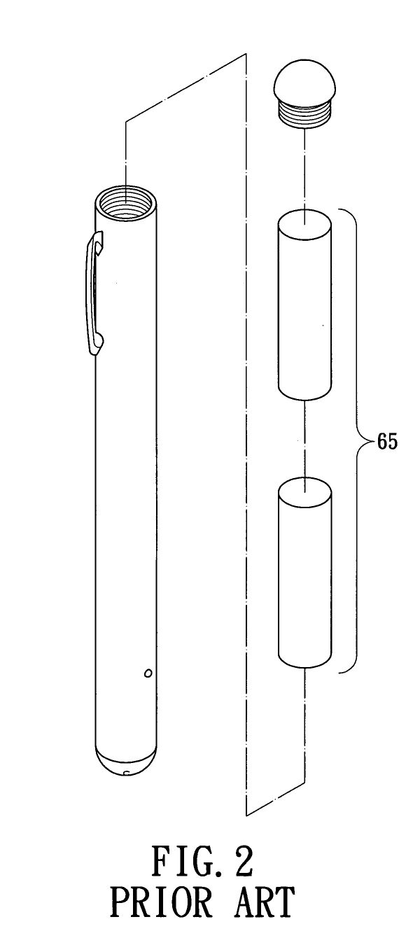

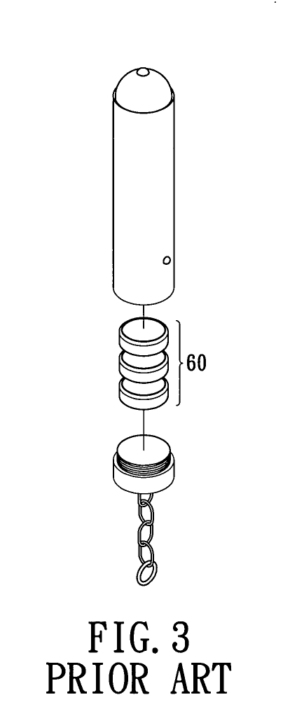

### DETAILED DESCRIPTION OF THE INVENTION

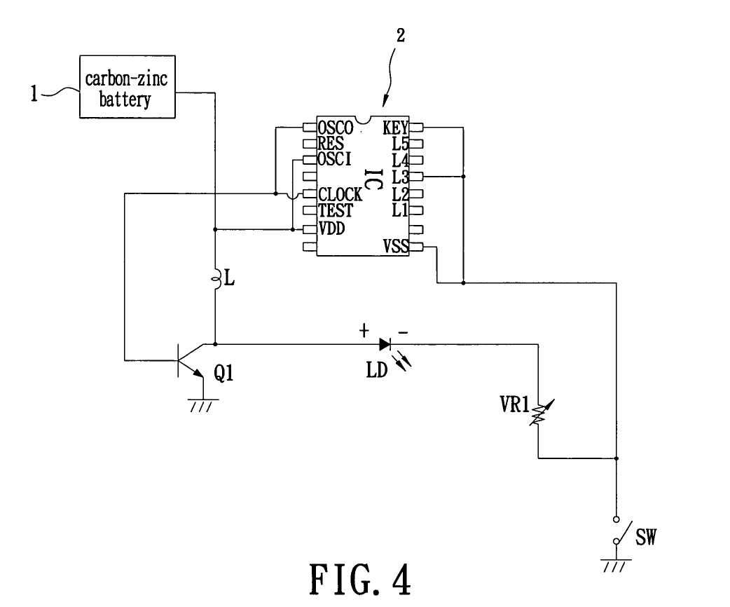

Please refer to FIG. 4, the invention provides a laser designator comprising a 1.5 V carbon-zinc battery (an 1.5 V alkaline battery and a 1.2 V nickel-metal hydride battery) 1, a control circuit 2, and a laser diode LD; wherein the electric output port of the carbon-zinc battery 1 is connected to the control circuit to transform the electricity of the 1.5 V carbon-zinc battery 1 into 3 V voltage level, and the 3 V output electricity is provided to the laser diode LD.

A control chip is provided in the control circuit, and has a VDD pin connected to the electric output port of the carbon-zinc battery and one end of an inductance L. The control ship has a clock output pin connected to the base of the transistor Q1. The emitter of the transistor Q1 is grounded, and furthermore the collector of the transistor Q1 is connected to the other end of the inductance L and one end of the laser diode LD. The other end of the laser diode LD is connected to one end of a variable resistance VR1, and the control chip has a VSS pin connected to a switch SW and the other end of the variable resistance VR1.

The clock pin of the control chip in control circuit 2 outputs a clock signal with frequency of 128 KHz. Furthermore, the inductance L and the transistor Q1 amplify the output current of the clock pin. A resistance R1 is used to regulate the power of the laser diode LD. The highest consuming current is about 60 to 120 mA in the circuit of the present invention.

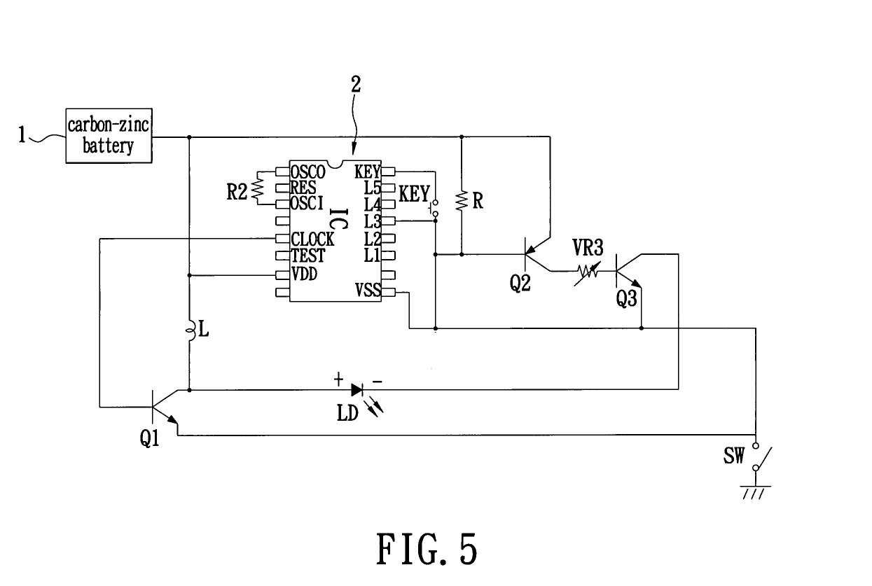

Please refer to FIG. 5, it's an output power circuit that transform the electric power 1.5 V of the carbon-zinc battery 1 into 4.5 V. A control chip is in the control circuit, and the VDD pin of the control chip is connected to the electric output port of the carbon-zinc battery and one end of the inductance L. The clock output pin of the control chip is connected to the base of the transistor Q1 and the collector of the transistor Q1 is connected to the other end of an inductance L and one end of the laser diode LD. The VSS pin of the control chip is connected to a switch SW, the other end of the resistance R and the base of a transistor Q2. The emitter of the transistor Q2 is connected to the other end of the resistance R and the electric output port of the carbon-zinc battery. The collector of the transistor Q2 is connected to the base of the transistor Q3 by a variable resistance VR3. The emitter of the transistor Q3 is connected to the switch SW and connected to the emitter of the transistor Q1. The collector of the transistor Q3 is connected to the other end laser diode LD.

The clock pin of the control chip in control circuit 2 outputs a clock signal with frequency of 128 KHz. Furthermore, the inductance L and the transistor Q1 amplify the output current of the clock pin. The transistor Q2 reverses the phase of the current and provide it for the laser diode LD. A resistance R3 is used to regulate the power of the laser diode LD and the highest consuming current is about 10 to 30 mA in the circuit of the present invention.

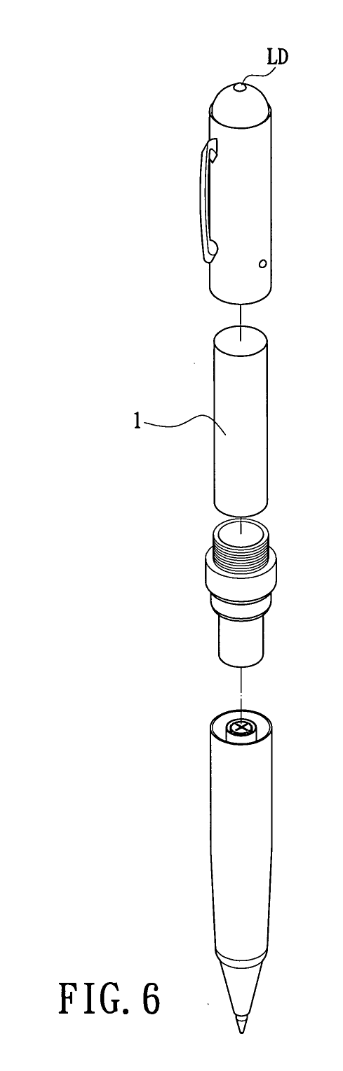

Please refer to FIG. 6, it depicts a laser-pointing pen according to a preferred embodiment in the present invention. The laser-pointing pen is started up by using a 1.5 V carbon-zinc battery 1 and a control circuit (not shown in the diagram).

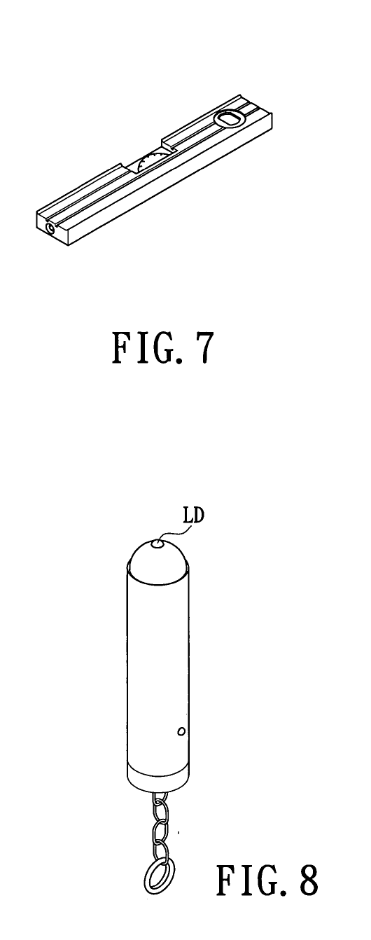

Please refer to FIG. 7, it shows a level according to another preferred embodiment in the present invention. The level is started up by using a 1.5 V carbon-zinc battery 1 and a control circuit (not shown in the diagram).

Please refer to FIG. 8, it shows a key ring according to still another preferred embodiment of the present invention. The key ring is started up by using a 1.5 V carbon-zinc battery 1 and a control circuit (not shown in the diagram).

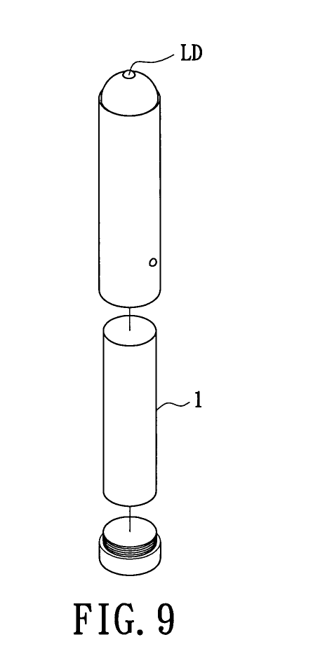

Please refer to FIG. 9, it shows a laser designator according to still another preferred embodiment in the present invention. The laser designator is started up by using a 1.5 V carbon-zinc battery 1 and a control circuit (not shown in the diagram).

Although the present invention has been described with reference to the preferred embodiment therefore, it will be understood that the invention is not limited to the details thereof. Various substitutions and modifications have suggested in the foregoing description, and other will occur to those of ordinary skill in the art. Therefore, all such substitutions and modifications are intended to be embrace within the scope of the invention as defined in the appended claims.

1. A laser designating devise, which comprising:
a battery; and
a control circuit connected to an electric output port of the battery and a laser diode, respectively; the control circuit transforming an output electric power of the battery into 3 V and supplying the electric power to the laser diode.

2. The improved laser designating devise as in claim 1, wherein the battery is a 1.5 V carbon-zinc battery.

3. The improved laser designating devise as in claim 1, wherein the battery is a 1.5 V alkaline battery.

4. The improved laser designating devise as in claim 1, wherein the battery is a 1.2 V nickel-metal hydride battery.

5. The improved laser designating devise as in claim 1, wherein the control circuit comprising:
a control chip with a VDD pin, a clock pin and a VSS pin stepping up the voltage potential and the VDD pin connected to the electric output port of the battery; and
a current amplifier connected to the VDD pin and clock pin in one end, and then grounded in the other end; the laser diode is connected between the output port of the current amplifier and the VSS pin of the control chip.

6. The improved laser designating devise as in claim 5, wherein the power of the laser diode is regulated by a variable resistance.

7. A laser designating devise, which comprising:
a battery; and
a control circuit connected to an electric output port of the battery and a laser diode, respectively; the control circuit transforming an output electricity of the battery into 4.5 V and offer it to the laser diode.

8. The improved laser designating devise as in claim 7, wherein the battery is a 1.5 V carbon-zinc battery.

9. The improved laser designating devise as in claim 7, wherein the battery is a 1.5 V alkaline battery.

10. The improved laser designating devise as in claim 7, wherein the battery is a 1.2 V nickel-metal hydride battery.

11. The improved laser designating devise as in claim 7, wherein the control circuit comprising:
a control chip with a VDD pin, and a clock pin and a VSS pin stepping up the voltage potential and the VDD pin connected to the electric output port of the battery;
a first current amplifier connected to the VDD pin and clock pin in one end; the first current amplifier having an output port connected to one end of the laser diode; and
a second current amplifier connected to the VSS pin and the electric output port of the battery; the second current amplifier having an output port connected to the other end of the laser diode.

12. The improved laser designating devise as in claim 11, further comprising a variable resistance to regulate a power of the laser diode.
